(19) United States
(12) Patent Application Publication
(10) Pub. No.: US 2015/0316222 A1
(43) Pub. Date: Nov. 5, 2015

(54) SUNLIGHT ILLUMINATION SYSTEM HAVING LIGHT INTENSITY ADJUSTMENT FUNCTION

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/269,259

(22) Filed: May 5, 2014

(51) Int. Cl. F21S 11/00; G02B 5/30; G02B 27/28

(52) U.S. Cl. CPC F21S 11/007; G02B 27/281; G02B 5/3058

(57) ABSTRACT

A sunlight illumination system includes a light collection device, a first light reflection polarizer, a second light reflection polarizer, and a third light reflection polarizer. The light collection device collects sunlight. The first light reflection polarizer splits the collected sunlight into a TE polarized light and a TM polarized light. The TM polarized light transmits through the first light reflection polarizer. The TE polarized light is reflected by the first light reflection polarizer. The TM polarized light is perpendicular to the TE polarized light. The second light reflection polarizer is positioned in an optical path of the TM polarized light and is rotated to adjust a light intensity of the TM polarized light. The third light reflection polarizer is positioned in an optical path of the TE polarized light and is rotated to adjust a light intensity of the TE polarized light.

### BACKGROUND

1. Technical Field

The present invention relates to illumination technologies, and particularly to a sunlight illumination system which has light intensity adjustment function.

2. Description of Related Art

As the demand for green technologies grows, the demand for increasingly efficient light sources has also increased as evidenced by the migration from incandescent light bulbs, to compact fluorescent light bulbs, and now on to light emitting diode light bulbs. While these newly developed light bulbs are more efficient relative to the traditional incandescent light bulbs, they may be far less efficient or more costly than using sunlight. Thus, different ways of gathering and redirecting sunlight to illuminate the interior of a building have been developed. A typical sunlight illumination system includes a collector for collecting and condensing sunlight and a light direction system for directing the collected sunlight to the interior of the building for illumination. However, the typical sunlight illumination system cannot adjust the intensity of the collected sunlight.

Therefore, it is desired to provide a sunlight illumination system that has light intensity adjustment function.

### BRIEF DESCRIPTION OF THE DRAWINGS

The components of the drawing are not necessarily drawn to scale, the emphasis instead being placed upon clearly illustrating the principles of the embodiments of the present disclosure.

FIG. 1 is a schematic view of a sunlight illumination system, in a first state.

FIG. 2 is a schematic view of the sunlight illumination system, in a second state.

FIG. 3 is a schematic view of a drive device of the sunlight illumination system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

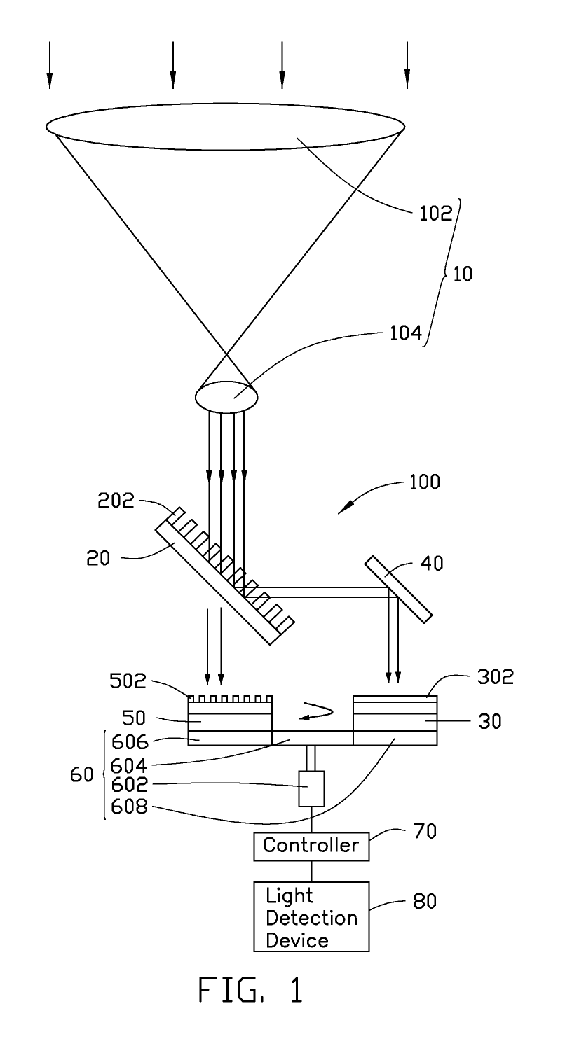

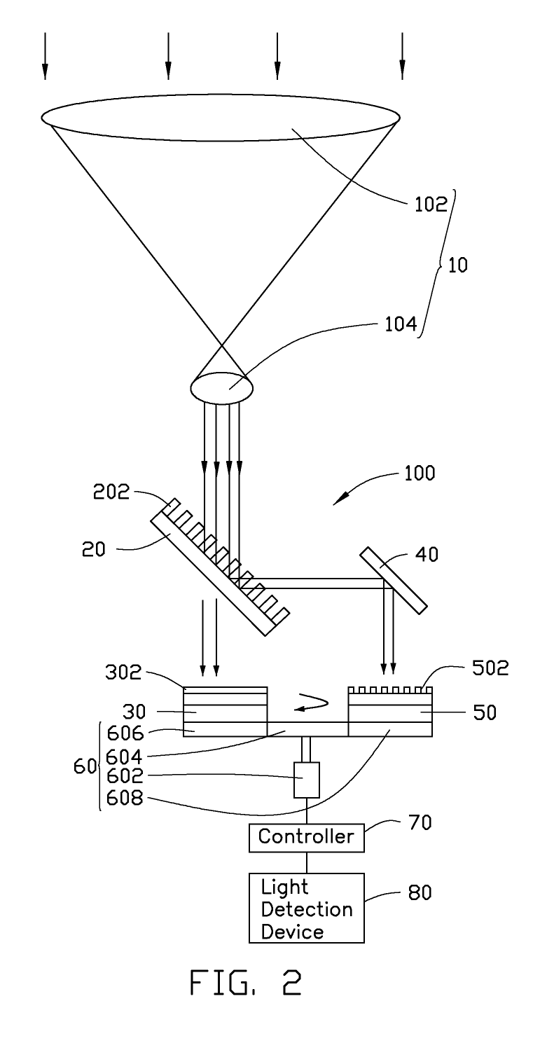

Referring to FIGS. 1 and 2, one embodiment of a sunlight illumination system 100 includes a light collection device 10, a first light reflection polarizer 20, a second light reflection polarizer 30, a light reflector 40, a third light reflection polarizer 50, a drive device 60, a controller 70 and a light detection device 80.

The light collection device 10 includes a lens system for condensing sunlight. In the illustrated embodiment, the light collection device 10 includes a first convex lens 102 and a second convex lens 104. Focuses of the first convex lens 102 and the second convex lens 104 are overlapped. The first convex lens 102 is configured to converge sunlight into a light point at the overlapped focuses of the first convex lens 102 and the second convex lens 104. The second convex lens 104 is configured to change the converged sunlight into parallel light.

The first light reflection polarizer 20 is configured to split the parallel light into a TE polarized light and a TM polarized light. The TE polarized light is reflected by the first light reflection polarizer 20. The TM polarized light is transmitted through the first light reflection polarizer 20. The TM polarized light is perpendicular to the TE polarized light. In the illustrated embodiment, the first light reflection polarizer 20 is a wire grid polarizer and includes a regular array of fine parallel first metallic wires 202, placed in a plane.

The second light reflection polarizer 30 is positioned in the optical path of the TM polarized light transmitted through the first light reflection polarizer 20. The second light reflection polarizer 30 is positioned on the driver device 60 and is configured to be rotated by the driver device 60 to adjust the light intensity of the TM polarized light transmitted through the second light reflection polarizer 30. In the illustrated embodiment, the second light reflection polarizer 30 is a wire grid polarizer and includes a regular array of fine parallel second metallic wires 302, placed in a plane.

The light reflector 40 is positioned in the optical path of the TE polarized light reflected by the first light reflection polarizer 20. The light reflector 40 reflects the TE polarized light in 90 degrees and makes the reflected TE polarized light parallel to the TM polarized light.

The third light reflection polarizer 50 is positioned in the optical path of the reflected TE polarized light. The third light reflection polarizer 50 is positioned on the driver device 60 and is configured to be rotated by the driver device 60 to adjust the light intensity of the reflected TM polarized light. In the illustrated embodiment, the third light reflection polarizer 50 is a wire grid polarizer and includes a regular array of fine parallel third metallic wires 502, placed in a plane. The third metallic wires 502 are positioned perpendicular to the second metallic wires 302.

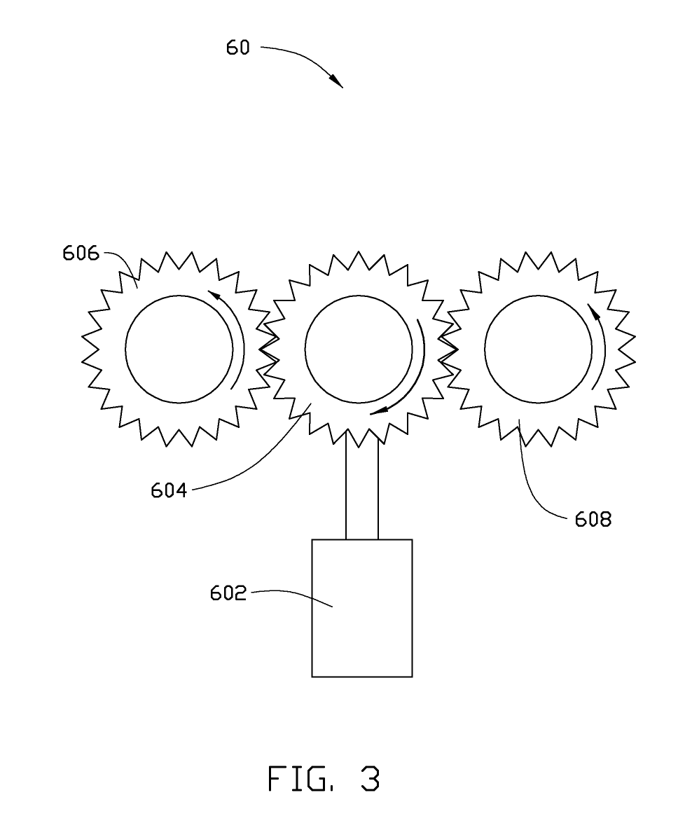

Also referring to FIG. 3, the drive device 60 includes a motor 602, a drive gear 604, a first driven gear 606, and a second driven gear 608. The motor 602 is connected to the drive gear 604 and configured to rotate the drive gear 604. The first driven gear 606 and the second driven gear 608 are positioned at two sides of the drive gear 604 and are opposite to each other. The first driven gear 606 and the second driven gear 608 mesh with the drive gear 604 and are configured to be synchronously rotated by the drive gear 604. The second light reflection polarizer 30 is positioned on the first driven gear 606. The third light reflection polarizer 50 is positioned on the second driven gear 608. Each of the second light reflection polarizer 30 and the third light reflection polarizer 50 is rotated to change an angle θ between the transmission axis and the polarization direction. Each of the TM polarized light and the reflected TE polarized light has energy I, the polarized light transmitted through the second light reflection polarizer 30 or the third light reflection polarizer 50 has energy I₀. I₀ follows the formula: I₀=I×cos(θ)². The second light reflection polarizer 30 and the third light reflection polarizer 50 are synchronously rotated to change the angle θ between the transmission axis and the polarization direction, the energy I₀ of the polarized light transmitted through the second light reflection polarizer 30 or the third light reflection polarizer 50 is changed accordingly.

The controller 70 is in communication with the motor 602 and the light detection device 80. The light detection device 80 is configured to detect light intensity of the interior of the building. The controller 70 is configured to control the motor 602 to drive the first driven gear 606 and the second driven gear 608, so as to change the angle θ between the transmission axis of the second light reflection polarizer 30 and the polarization direction of the TM polarized light and change the angle θ between the transmission axis of the third light reflection polarizer 50 and the polarization direction of the reflected TE polarized light. As a result, the light intensity of the polarized light transmitted through the second light reflection polarizer 30 and the third light reflection polarizer 50 is adjusted.

In use, when in a first state (please see FIG. 1), the transmission axis of the second light reflection polarizer 30 is parallel to the polarization direction of the TM polarized light, and the TM polarized light is totally transmitted through the second light reflection polarizer 30; the transmission axis of the third light reflection polarizer 50 is parallel to the polarization direction of the reflected TE polarized light, and the reflected TE polarized light is totally transmitted through the third light reflection polarizer 50. The polarized light transmitted through the second light reflection polarizer 30 and the third light reflection polarizer 50 is directed into the building for illumination. When in a second state (please see FIG. 2), the transmission axis of the second light reflection polarizer 30 is perpendicular to the polarization direction of the TM polarized light, and the TM polarized light is totally reflected by the second light reflection polarizer 30; the transmission axis of the third light reflection polarizer 50 is perpendicular to the polarization direction of the reflected TE polarized light, and the reflected TE polarized light is totally reflected by the third light reflection polarizer 50. As a result, the sunlight illumination system 100 can adjust the intensity of the collected sunlight for illumination between the first state and the second state.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A sunlight illumination system, comprising:
a light collection device configured to collect sunlight;
a first light reflection polarizer configured to split the collected sunlight into a TE polarized light and a TM polarized light, the TM polarized light transmitted through the first light reflection polarizer, the TE polarized light reflected by the first light reflection polarizer, the TM polarized light perpendicular to the TE polarized light;
a second light reflection polarizer positioned in an optical path of the TM polarized light transmitted through the first light reflection polarizer, the second light reflection polarizer configured to be rotated to adjust a light intensity of the TM polarized light; and
a third light reflection polarizer positioned in an optical path of the TE polarized light, the third light reflection polarizer configured to be rotated to adjust a light intensity of the TE polarized light.

2. The sunlight illumination system of claim 1, wherein the light collection device comprises a first convex lens and a second convex lens, focuses of the first convex lens and the second convex lens are overlapped, the first convex lens is configured to converge the sunlight into a light point at the overlapped focuses of the first convex lens and the second convex lens, the second convex lens is configured to change the converged sunlight into parallel light, and the first light reflection polarizer is configured to split the parallel light into the TE polarized light and the TM polarized light.

3. The sunlight illumination system of claim 1, wherein the first light reflection polarizer is a wire grid polarizer and comprises a regular array of parallel first metallic wires placed in a plane.

4. The sunlight illumination system of claim 1, wherein the second light reflection polarizer is a wire grid polarizer and comprises a regular array of parallel second metallic wires placed in a plane.

5. The sunlight illumination system of claim 4, comprising a light reflector, the light reflector configured to reflect the TE polarized light 90 degrees to the third light reflection polarizer and configured to make the reflected TE polarized light parallel to the TM polarized light.

6. The sunlight illumination system of claim 5, wherein the third light reflection polarizer is a wire grid polarizer and comprises a regular array of parallel third metallic wires placed in a plane, and the third metallic wires are positioned perpendicular to the second metallic wires.

7. The sunlight illumination system of claim 6, comprising a drive device, the drive device configured to drive the second light reflection polarizer and the third light reflection polarizer to rotate at the same time, such that the light intensity of the TM polarized light is adjusted by the second light reflection polarizer and the light intensity of the TE polarized light is adjusted by the third light reflection polarizer.

8. The sunlight illumination system of claim 7, wherein the drive device comprises a motor, a drive gear, a first driven gear, and a second driven gear, the motor is connected to the drive gear and configured to rotate the drive gear, the first driven gear and the second driven gear mesh with the drive gear and are configured to be synchronously rotated by the drive gear, the second light reflection polarizer is positioned on the first driven gear, and the third light reflection polarizer is positioned on the second driven gear.

9. The sunlight illumination system of claim 8, wherein each of the TM polarized light and the reflected TE polarized light has energy I, the polarized light transmitted through the second light reflection polarizer or the third light reflection polarizer has energy I₀, I₀ follows the formula: I₀=I×cos(θ)², θ represents an angle between a transmission axis of the second light reflection polarizer and a polarization direction of the TM polarized light, θ also represents an angle between a transmission axis of the third light reflection polarizer and a polarization direction of the reflected TE polarized light.

10. The sunlight illumination system of claim 9, wherein when in a first state, the transmission axis of the second light reflection polarizer is parallel to the polarization direction of the TM polarized light, and the TM polarized light is totally transmitted through the second light reflection polarizer; the transmission axis of the third light reflection polarizer is parallel to the polarization direction of the reflected TE polarized light, and the reflected TE polarized light is totally transmitted through the third light reflection polarizer; when in a second state, the transmission axis of the second light reflection polarizer is perpendicular to the polarization direction of the TM polarized light, and the TM polarized light is totally reflected by the second light reflection polarizer; the transmission axis of the third light reflection polarizer is perpendicular to the polarization direction of the reflected TE polarized light, and the reflected TE polarized light is totally reflected by the third light reflection polarizer.

11. The sunlight illumination system of claim 9, comprising a controller and a light detection device, the controller in communication with the motor and the light detection device, the light detection device configured to detect light intensity of the interior of a building, the controller configured to control the motor to drive the first driven gear and the second driven gear, so as to change the angle θ between the transmission axis of the second light reflection polarizer and the polarization direction of the TM polarized light and change the angle θ between the transmission axis of the third light reflection polarizer and the polarization direction of the reflected TE polarized light.
